(19) United States
(12) Patent Application Publication
(10) Pub. No.: US 2007/0244889 A1
(43) Pub. Date: Oct. 18, 2007

(54) Byte string searching apparatus and searching method

(75) Inventor: Toshihide Fujiyoshi, Kawasaki-shi (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 11/727,893

(22) Filed: Mar. 28, 2007

(30) Foreign Application Priority Data
Mar. 30, 2006 (JP) 2006-093844

(51) Int. Cl. G06F 17/30

(52) U.S. Cl. 707/6

(57) ABSTRACT

According to the present invention, there is provided a byte string searching apparatus for searching for a search object byte string including a (a is an integer of not less than 2) consecutive bytes, having: a comparators each of which compares externally input first data having n (n is an integer of not less than a) bytes with one of bytes from a first byte to an ath byte of the search object byte string, and outputs a comparison result indicating a match/mismatch of each byte; and a logic operation circuit which executes a logic operation by using the comparison results from the comparators, thereby outputting the presence/absence of a byte string having a consecutive bytes, wherein the a comparators select different bytes from the first byte to the ath byte of the search object byte string, and output the comparison results in parallel.

### CROSS REFERENCE TO RELATED APPLICATION

This application is based upon and claims benefit of priority under 35 USC §119 from the Japanese Patent Application No. 2006-93844, filed on Mar. 30, 2006, the entire contents of which are incorporated herein by reference.

### BACKGROUND OF THE INVENTION

The present invention relates to a byte string searching apparatus and searching method.

The storage position of music data or moving image data can be specified from a predetermined file format such as MP4 by referring to header information (e.g., non patent reference 1 to be described later).

To decode a plurality of moving image data from a bit stream of, e.g., H. 264 compressed data, however, it is necessary to search for a start code placed at the head of each moving image data contained in the bit stream because there is no header information. This start code is a specific byte string (to be referred to as a search object byte string hereinafter).

Sequential processing is necessary to search for this search object byte string by using a general central processing unit (to be referred to as a CPU hereinafter) without any dedicated circuit. The sequential processing is to compare bytes, one by one from the head of the bit stream, with the search object byte string. The following processes are necessary if, for example, the search object byte string consists of three bytes from first to third bytes.

(A) A byte is read from the head of the bit stream, and compared with the first byte of the search object byte string. If the two bytes match, the process advances to (B). If the two bytes do not match, a next byte following the already compared byte is read and compared with the first byte of the search object byte string. Bytes are repetitively read and compared one by one with the first byte until the two bytes match.

(B) A next byte following the byte compared in (A) is read from the bit stream, and compared with the second byte of the search object byte string. If the two bytes match, the process advances to (C). If the two bytes do not match, the process returns to (A) to resume the comparison from a next byte following the byte compared in (A).

(C) A next byte following the byte compared in (B) is read from the bit stream, and compared with the third byte of the search object byte string. If the two bytes match, the processing completes. If the two bytes do not match, the process returns to (A) to resume the comparison from a next byte following the byte compared in (A).

Unfortunately, the conventional method based on the above sequential processing has the following limitations. Even when a high speed circuit process is used, therefore, the past search log cannot be effectively used. This makes it difficult to increase the processing speed.

1) A bit stream processable by each procedure is limited to one byte.

2) If in a search object byte string having a (a is an integer of 2 or more) bytes a mismatch occurs at the kth (k is an integer from 2 (inclusive) to a (inclusive)) byte, comparison is resumed from the position of the second byte next to the first byte in order to search for the kth byte, although the contents of a bit stream from the first byte to the (k−1)th byte are known.

Non-patent reference 1: ISO 14496-14

### SUMMARY OF THE INVENTION

According to one aspect of the present invention, there is provided a byte string searching apparatus for searching for a search object byte string including a (a is an integer of not less than 2) consecutive bytes, comprising:

a comparators each of which compares externally input first data having n (n is an integer of not less than a) bytes with one of bytes from a first byte to an ath byte of the search object byte string, and outputs a comparison result indicating a match/mismatch of each byte; and

a logic operation circuit which executes a logic operation by using the comparison results from said comparators, thereby outputting the presence/absence of a byte string having a consecutive bytes,

wherein said a comparators select different bytes from the first byte to the ath byte of the search object byte string, and output the comparison results in parallel.

According to one aspect of the present invention, there is provided a byte string searching method of searching for a search object byte string including a (a is an integer of not less than 2) consecutive bytes, comprising:

allowing a comparators to compare externally input first data having n (n is an integer of not less than a) bytes with one of bytes from a first byte to an ath byte of the search object byte string, and output comparison results indicating a match/mismatch of each byte; and

allowing a logic operation circuit to execute a logic operation by using the comparison results from the comparators, thereby outputting the presence/absence of a byte string having a consecutive bytes,

wherein when the comparison results are output from the a comparators, different bytes are selected from the first byte to the ath byte of the search object byte string, and the comparison results are output in parallel.

### BRIEF DESCRIPTION OF THE DRAWINGS

FIG. 1 is a block diagram showing the arrangement of a byte string searching apparatus according to the first embodiment of the present invention;

FIG. 2 is a flowchart showing the procedure of a byte string searching method according to the first embodiment;

FIG. 3 is a view for explaining the configuration of a bit stream of H. 264 moving image data to be input to the byte string searching apparatus according to the first embodiment;

FIG. 4 is a circuit diagram showing the arrangement of a byte comparator included in the byte string searching apparatus according to the first embodiment;

FIG. 5 is a block diagram showing the arrangement of a byte string searching apparatus according to the second embodiment of the present invention;

FIG. 6 is a block diagram showing the arrangement of a byte string searching apparatus according to the third embodiment of the present invention;

FIG. 7 is a flowchart showing the procedure of a byte string searching method according to the third embodiment; and

FIG. 8 is a block diagram showing the arrangement of a byte string searching apparatus according to the fourth embodiment of the present invention.

### DETAILED DESCRIPTION OF THE INVENTION

Byte string searching apparatuses and searching methods according to embodiments of the present invention will be explained below with reference to the accompanying drawings.

Each embodiment executes a byte string searching process at high speed by using the following properties of a search object byte string.

I) A maximum length (a bytes; a is an integer of 2 or more) of the search object byte string is determined.

II) A code having a plurality of bytes continuously arranged on the byte basis is an object of search.

Note that the maximum length of the search object byte string is, e.g., 3 bytes (24 bits).

### (1) First Embodiment

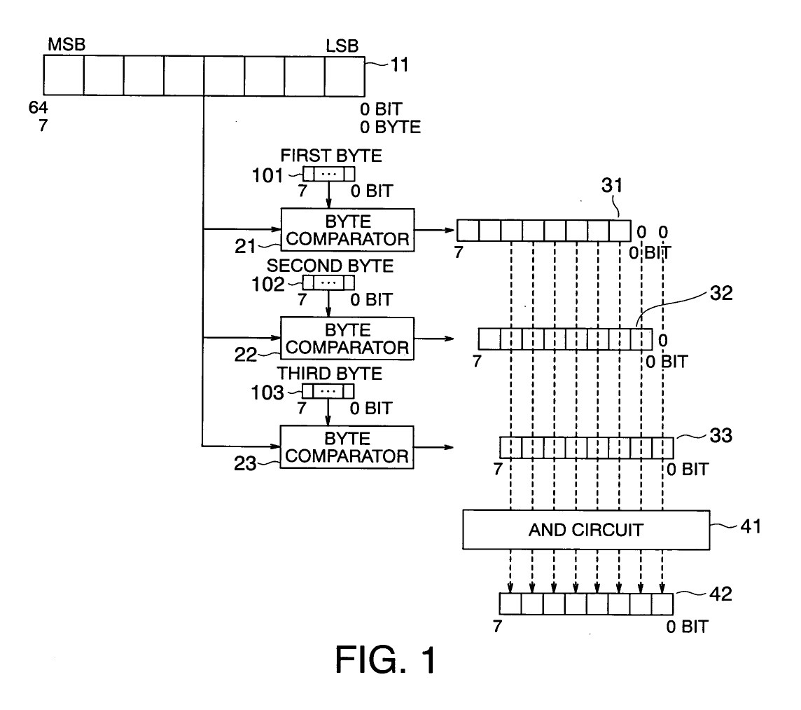

FIG. 1 shows the arrangement of a byte string searching apparatus according to the first embodiment.

Note that this byte string searching apparatus according to the first embodiment, data is stored as it is sequentially packed from the least significant bit (LSB) toward upper bits of a register.

This byte string searching apparatus comprises an input buffer 11, byte comparators 21 to 23, match/mismatch map registers 31 to 33, an AND circuit 41, and an output register 42.

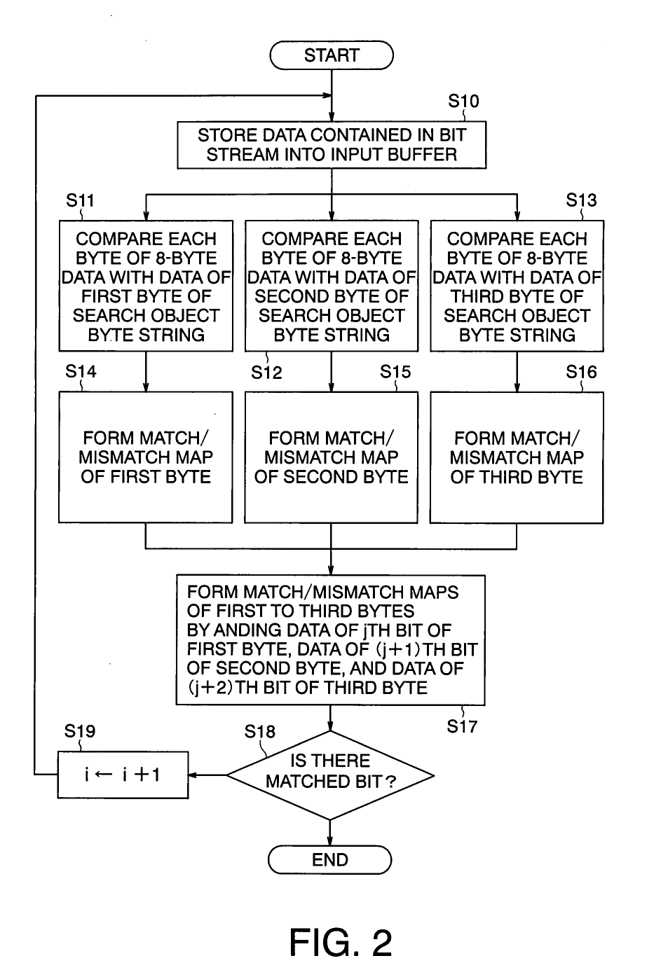

FIG. 2 is a flowchart showing the procedure of processing performed by a byte string searching method according to the first embodiment.

In step S10 of FIG. 2, the input buffer 11 stores data of, e.g., 64 bits, i.e., 8 bytes, of a bit stream transferred from an external apparatus (not shown). Although the number of bytes is 8 in this embodiment, it may also be another number.

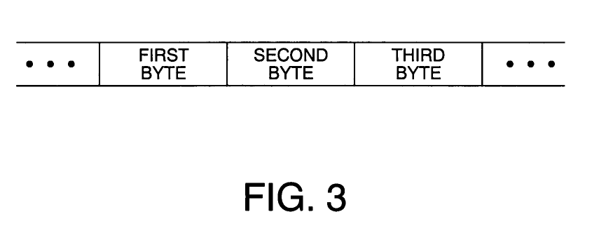

The bit stream of data transmitted from the external apparatus (not shown) is, e.g., byte aligned data such as H. 264 data shown in FIG. 3. This bit stream contains a plurality of moving image data. The head of each moving image data is a start code having first, second, and third bytes as shown in FIG. 3. The first, second, and third bytes form a search object byte string.

In step S11, the input buffer 11 supplies the stored 8 byte data to the byte comparator 21. The byte comparator 21 compares this data with 8 bit data 101 of the first byte contained in the search object byte string, and determines a match or mismatch of each byte.

In step S14, the byte comparator 21 supplies the determination result to the 8 bit, match/mismatch map register 31. In each portion where two bytes match, “1”, for example, is written in a corresponding bit. “0” is written in a bit corresponding to a mismatch.

In this manner, a map indicating a match/mismatch of each byte between the data from the input buffer 11 and the data 101 of the first byte of the search object byte string is formed.

In parallel with steps S11 and S14, the input buffer 11 supplies the stored data to the byte comparator 22 in step S12. The byte comparator 22 compares this data with data 102 of the second byte of the search object byte string, and determines a match or mismatch of each byte.

In step S15, the byte comparator 22 supplies this determination result to each bit of the match/mismatch map register 32, thereby forming a match/mismatch map for the second byte data 102.

Similarly, in step S13, the input buffer 11 supplies the 8 byte data to the byte comparator 23. The byte comparator 23 compares this data with data 103 of the third byte of the search object byte string, and determines a match or mismatch of each byte.

In step S16, the byte comparator 23 supplies this determination result to each bit of the match/mismatch map register 33, thereby forming a match/mismatch map for the third byte data 103.

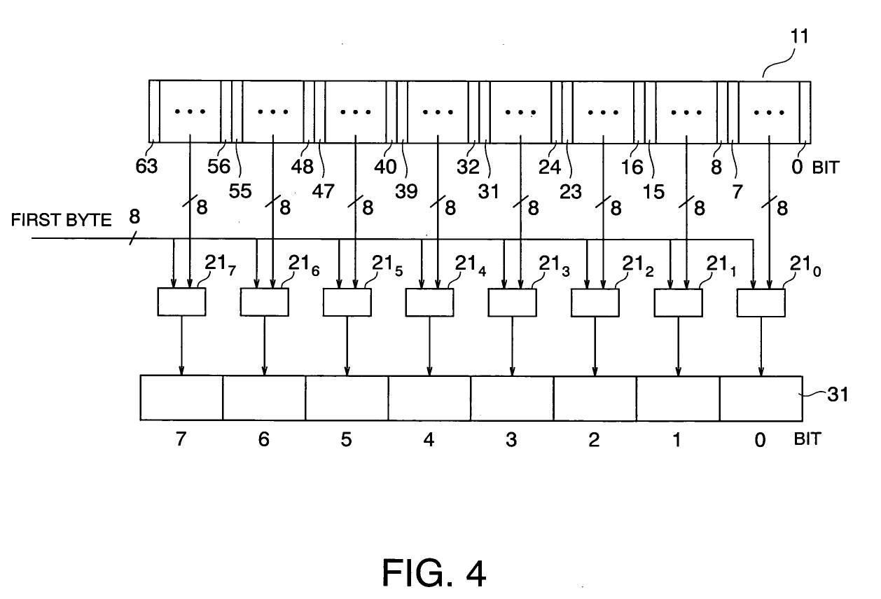

FIG. 4 shows the connections between the input buffer 11, the byte comparator 21 having comparators 21₀ to 21₇, and the match/mismatch map register 31. Of the stored 8 byte data, the input buffer 11 supplies each of eight 1 byte data having bits 0 to 7, 8 to 15, . . . , 56 to 63 to a corresponding one of the comparators 21₀, 21₁, . . . , 21₇.

On the other hand, the first byte data 101 is supplied to all the comparators 21₀ to 21₇, and compared with the data from the input buffer 11. The comparison results are supplied to and stored in bits 0 to 7 of the match/mismatch map register 31.

In step S17, the AND circuit 41 performs a logic operation, i.e., an AND operation on each bit of the match/mismatch map registers 31 to 33. As shown in FIG. 1 and step S17 of FIG. 2, the AND circuit 41 performs the AND operation on each bit while the match/mismatch map register 31 is shifted two bits to the left (the upper bit side) and the match/mismatch map register 32 is shifted one bit to the left.

That is, the AND circuit 41 performs an AND operation of the first bit indicating a match/mismatch of the third byte held in the match/mismatch map register 33, a value “0” indicating a mismatch, and “0”.

The AND circuit 41 performs an AND operation of the second bit held in the match/mismatch map register 33 and indicating a match/mismatch of the third byte, the first bit held in the match/mismatch map register 32 and indicating a match/mismatch of the second byte, and “0”.

The AND circuit 41 performs an AND operation of the third bit held in the match/mismatch map register 33 and indicating a match/mismatch of the third byte, the second bit held in the match/mismatch map register 32 and indicating a match/mismatch of the second byte, and the first bit held in the match/mismatch map register 31 and indicating a match/mismatch of the first byte.

The AND circuit 41 performs an AND operation of the (j+2)th (j is 1 (inclusive) to the number of bits (n−2) (inclusive); in this embodiment, j is an integer of 6 or less) bit held in the match/mismatch map register 33 and indicating a match/mismatch of the third byte, the (j+1)th bit held in the match/mismatch map register 32 and indicating a match/mismatch of the second byte, and the jth bit held in the match/mismatch map register 31 and indicating a match/mismatch of the first byte.

The AND circuit 41 performs an AND operation of the eighth bit held in the match/mismatch map register 33 and indicating a match/mismatch of the third byte, the seventh bit held in the match/mismatch map register 32 and indicating a match/mismatch of the second byte, and the sixth bit held in the match/mismatch map register 31 and indicating a match/mismatch of the first byte.

As described above, the AND circuit 41 performs AND operations between positions shifted one bit from each other in the match/mismatch map registers 31 to 33.

The validity register 42 receives and stores the results of the AND operations for each bit. In this way, match/mismatch maps of the first to third bytes are formed.

If in step S18 a bit storing a value “1” indicating that the 3 byte search object byte string is found exists in the validity register 42, the processing is terminated. In this case, in a portion corresponding to this bit position, the search object byte string having three bits exists in the input buffer 11.

This bit position holding the value “1” in the validity register 42 corresponds to the bit position in the third byte of the search object byte string.

If in step S18 no “1” exists in any bit of the validity register 42, the process advances to step S19.

In step S19, a pointer i (i is an integer of 1 or more) of eight bytes, i.e., the number of bytes that the input buffer 11 can store, is advanced by +1, and the next 8 byte data is received from the bit stream and stored. The process then returns to step S10 to repeat the same processing.

The first embodiment can achieve the following functions and effects. Match/mismatch determination processes for individual bytes of a search object byte string can be executed in parallel. This can greatly increase the processing speed compared to sequential processing using a CPU.

Also, in the procedures of finally obtaining match/mismatch maps indicating byte positions where the 3 byte search object byte string and data from the input buffer 11 match, an operation of reading data from a bit stream need only be performed once to execute the match/mismatch determination process. Therefore, no waste occurs due to “reread” that happens in sequential processing using a CPU.

Furthermore, the circuit configuration of the byte string searching apparatus according to the first embodiment includes the byte comparators 21 to 23, the AND circuit 41, and small scale registers, i.e., the input buffer 11, match/mismatch map registers 31 to 33, and validity register 42. Accordingly, the circuit area is small, and the power consumption is also low. This contributes to cost reduction.

In addition, a high speed operation is possible because the arithmetic logic in the AND circuit 41 is simple.

### (2) Second Embodiment

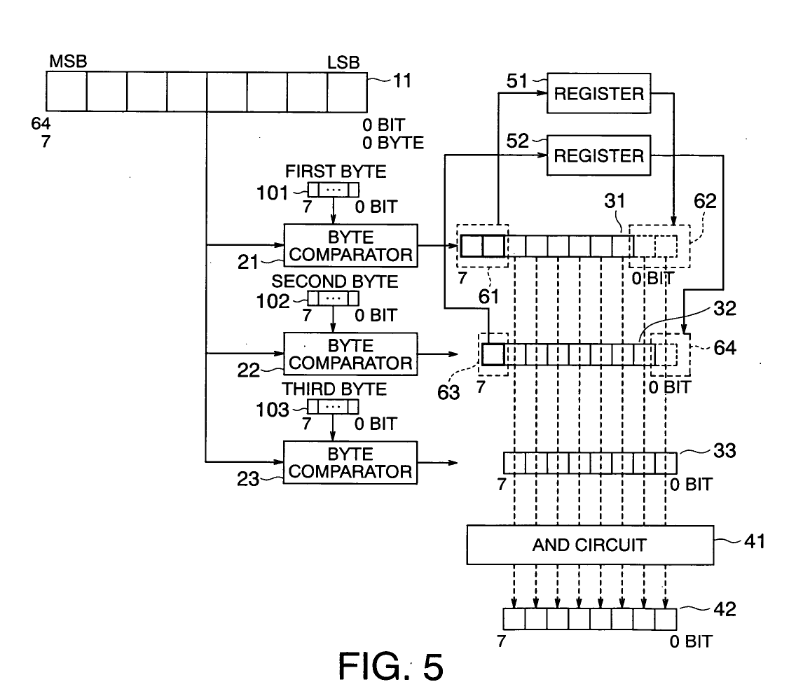

FIG. 5 shows the arrangement of a byte string searching apparatus according to the second embodiment.

Note that this byte string searching apparatus according to the second embodiment comprises a configuration similar to that of the first embodiment.

The first embodiment can perform search only when 8 byte data stored in the input buffer 11 contains all of three search object bytes.

By contrast, the second embodiment has an arrangement capable of search even when three search object bytes exist over 8 byte data stored in an input buffer 11 and data before or after this 8 byte data.

As shown in FIG. 5, the byte string searching apparatus according to the second embodiment includes a register 51 storing data 61 of the seventh and eighth bits of a map indicating a match/mismatch of the first byte of search object bytes corresponding to the last stored data in the input buffer 11, in a match/mismatch map register 31 storing a match/mismatch map of the first byte of the search object bytes.

The data 61 stored in the register 51 is regarded as being placed as 2 bit data 62 on the right side (the least significant bit side) of the first bit of the map indicating a match/mismatch of the first byte of the search object bytes corresponding to the current stored data in the input buffer 11.

Similarly, the byte string searching apparatus includes a register 52 storing data 63 of the eighth bit of a map indicating a match/mismatch of the second byte of the search object bytes corresponding to the last stored data in the input buffer 11, in a match/mismatch map register 32 storing a match/mismatch map of the second byte of the search object bytes.

The data 63 stored in the register 52 is regarded as being placed as 1 bit data 64 on the right side of the first bit of a map indicating a match/mismatch of the second byte of the search object bytes corresponding to the current stored data in the input buffer 11.

In the second embodiment, an AND circuit 41 performs the following AND operations.

That is, the AND circuit 41 performs an AND operation of the first bit held in a match/mismatch map register 33 and indicating a match/mismatch of the third byte, the eighth bit lastly held in the match/mismatch map register 32, currently held in the register 52, and indicating a match/mismatch of the second byte, and the seventh bit lastly held in the match/mismatch map register 31, currently held in the register 51, and indicating a match/mismatch of the first byte.

The AND circuit 41 performs an AND operation of the second bit held in the match/mismatch map register 33 and indicating a match/mismatch of the third byte, the first bit held in the match/mismatch map register 32 and indicating a match/mismatch of the second byte, and the eighth bit lastly held in the match/mismatch map register 31, currently held in the register 51, and indicating a match/mismatch of the first byte.

The AND circuit 41 performs an AND operation of the third bit held in the match/mismatch map register 33 and indicating a match/mismatch of the third byte, the second bit held in the match/mismatch map register 32 and indicating a match/mismatch of the second byte, and the first bit held in the match/mismatch map register 31 and indicating a match/mismatch of the first byte.

The AND circuit 41 performs an AND operation of the (j+2)th (j is 1 (inclusive) to the number of bits (n−2) (inclusive); in this embodiment, j is an integer of 6 or less) bit held in the match/mismatch map register 33 and indicating a match/mismatch of the third byte, the (j+1)th bit held in the match/mismatch map register 32 and indicating a match/mismatch of the second byte, and the jth bit held in the match/mismatch map register 31 and indicating a match/mismatch of the first byte.

The AND circuit 41 performs an AND operation of the eighth bit held in the match/mismatch map register 33 and indicating a match/mismatch of the third byte, the seventh bit held in the match/mismatch map register 32 and indicating a match/mismatch of the second byte, and the sixth bit held in the match/mismatch map register 31 and indicating a match/mismatch of the first byte.

A validity register 42 stores the operation results from the AND circuit 41 as in the first embodiment.

The second embodiment can perform search even when three search object bytes exist over data of eight bytes that can be stored in the input register 11 and data before or after this 8 byte data.

### (3) Third Embodiment

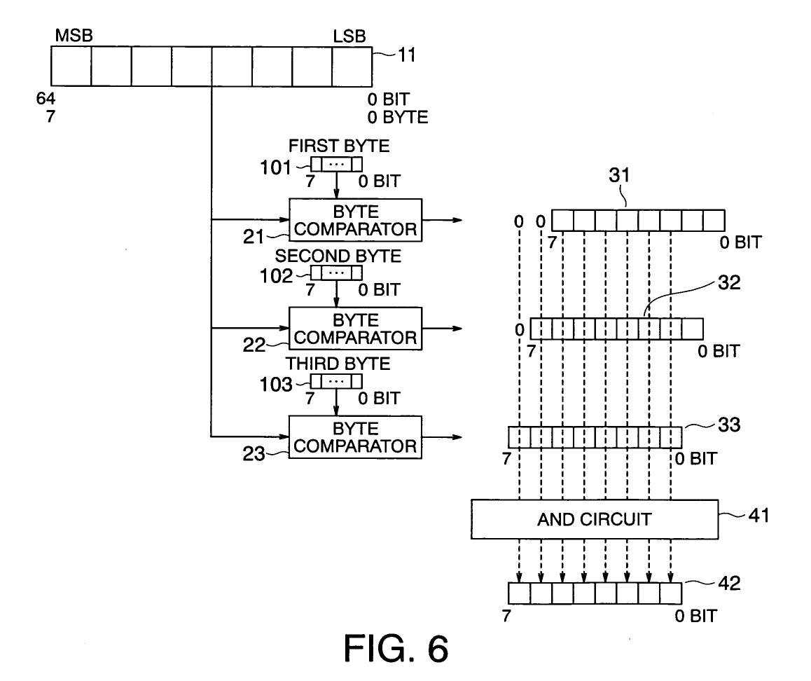

A byte comparator according to the third embodiment of the present invention will be explained below with reference to FIG. 6 showing the arrangement of the comparator. A byte string searching apparatus according to the third embodiment, data is stored as it is sequentially packed from the most significant bit (MSB) toward lower bits of a register. The rest of the arrangement is the same as the first embodiment, so an explanation thereof will be omitted.

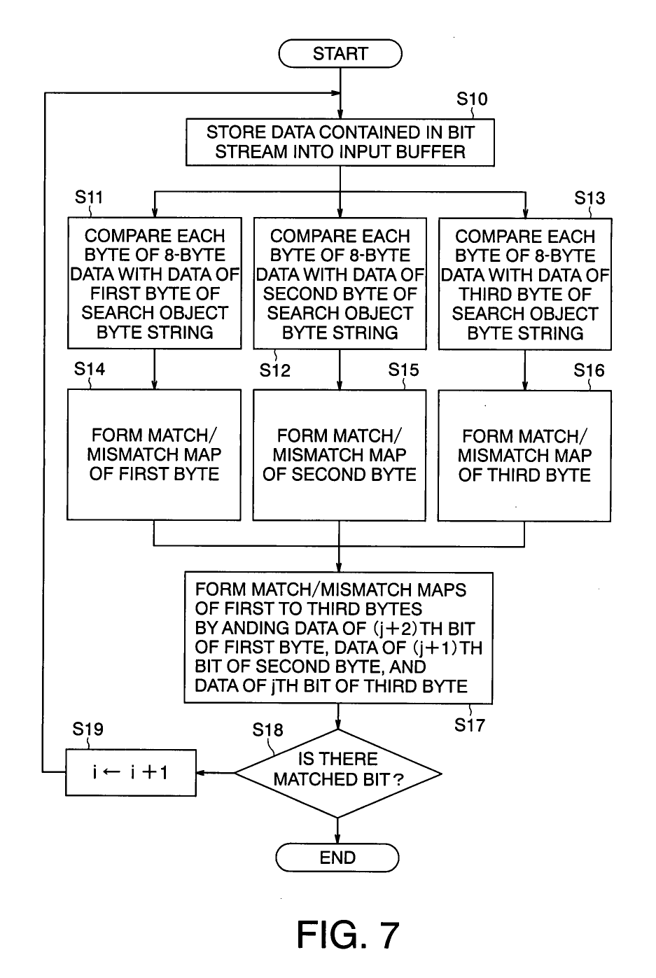

The first embodiment performs the byte searching process in accordance with the flowchart shown in FIG. 2. However, the third embodiment performs processing in accordance with a flowchart shown in FIG. 7.

The third embodiment shown in FIG. 7 differs from the first embodiment shown in FIG. 2 in data that an AND circuit 41 uses in step S17 to perform an AND operation on each bit in match/mismatch map registers 31 to 33.

The third embodiment performs the AND operation on each bit while the match/mismatch map register 31 is shifted two bits to the right (the lower bit side), and the match/mismatch map register 32 is shifted one bit to the right.

That is, the AND circuit 41 performs an AND operation of the first bit held in the match/mismatch map register 33 and indicating a match/mismatch of the third byte, the second bit held in the match/mismatch map register 32 and indicating a match/mismatch of the second byte, and the third bit held in the match/mismatch map register 31 and indicating a match/mismatch of the first byte.

The AND circuit 41 performs an AND operation of the second bit held in the match/mismatch map register 33 and indicating a match/mismatch of the third byte, the third bit held in the match/mismatch map register 32 and indicating a match/mismatch of the third byte, and the fourth bit held in the match/mismatch map register 31 and indicating a match/mismatch of the first byte.

The AND circuit 41 performs an AND operation of the jth bit held in the match/mismatch map register 33 and indicating a match/mismatch of the third byte, the (j+1)th bit held in the match/mismatch map register 32 and indicating a match/mismatch of the second byte, and the (j+2)th bit held in the match/mismatch map register 31 and indicating a match/mismatch of the first byte.

The AND circuit 41 performs an AND operation of the seventh bit held in the match/mismatch map register 33 and indicating a match/mismatch of the third byte, the eighth bit held in the match/mismatch map register 32 and indicating a match/mismatch of the second byte, and a value “0” indicating a mismatch.

The AND circuit 41 performs an AND operation of the eighth bit held in the match/mismatch map register 33 and indicating a match/mismatch of the third byte, the value “0”, and the value “0”. Thus, the AND circuit 41 performs the AND operations between the positions shifted one bit from each other in the match/mismatch map registers 31 to 33.

As in the first embodiment, a validity register 42 receives and holds the results of the AND operations on the bit basis. In this manner, match/mismatch maps of the first to third bytes are formed.

Similar to the first embodiment, the third embodiment can execute match/mismatch searching processes in parallel on the individual bytes of the search object byte string. This makes it possible to greatly increase the processing speed compared to sequential processing using a CPU.

### (4) Fourth Embodiment

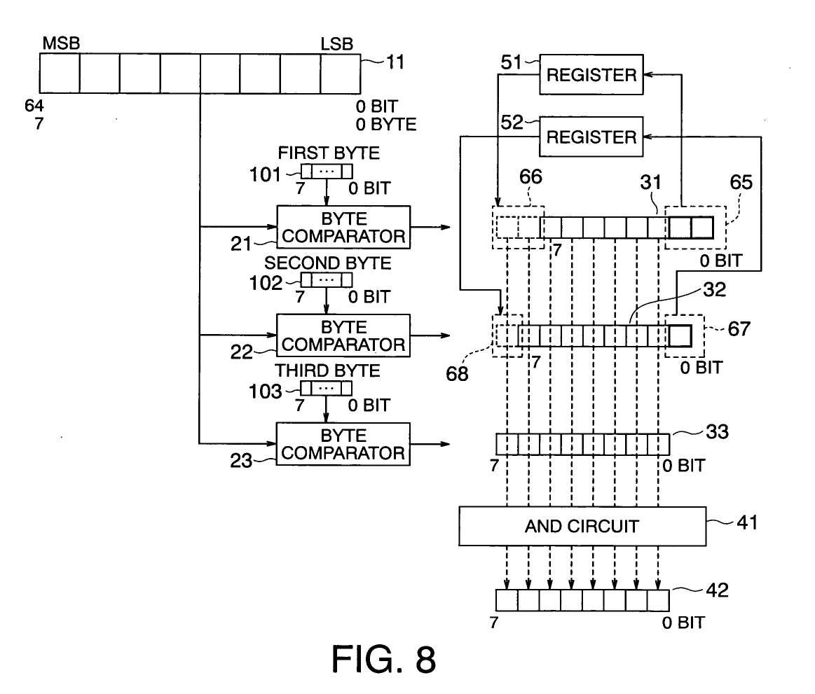

FIG. 8 shows the arrangement of a byte comparator according to the fourth embodiment of the present invention. A byte string searching apparatus according to the fourth embodiment comprises a configuration similar to that of the third embodiment.

As in the second embodiment, the fourth embodiment can perform search even when three search object bytes exist over 8 byte data stored in an input buffer 11 and data before or after this 8 byte data.

Unlike in the second embodiment, however, the fourth embodiment includes a register 51 storing data 65 of the first and second bits of a map indicating a match/mismatch of the first byte of search object bytes corresponding to the last stored data in the input buffer 11, in a match/mismatch map register 31 storing a match/mismatch map of the first byte of the search object bytes.

The data 65 stored in the register 51 is regarded as being placed as 2 bit data 66 on the left side (the most significant bit side) of the first bit of the map indicating a match/mismatch of the first byte of the search object bytes corresponding to the current stored data in the input buffer 11.

Similarly, the fourth embodiment includes a register 52 storing data 67 of the first bit of a map indicating a match/mismatch of the second byte of the search object bytes corresponding to the last stored data in the input buffer 11, in a match/mismatch map register 32 storing a match/mismatch map of the second byte of the search object bytes.

The data 67 stored in the register 52 is regarded as being placed as 1 bit data 68 on the left side of the first bit of a map indicating a match/mismatch of the second byte of the search object bytes corresponding to the current stored data in the input buffer 11. The rest of the arrangement is the same as in the second embodiment, so an explanation thereof will be omitted.

In the fourth embodiment, an AND circuit 41 performs the following AND operations.

That is, the AND circuit 41 performs an AND operation of the first bit held in a match/mismatch map register 33 and indicating a match/mismatch of the third byte, the second bit held in the match/mismatch map register 32 and indicating a match/mismatch of the second byte, and the third bit held in the match/mismatch map register 31 and indicating a match/mismatch of the first byte.

The AND circuit 41 performs an AND operation of the second bit held in the match/mismatch map register 33 and indicating a match/mismatch of the third byte, the third bit held in the match/mismatch map register 32 and indicating a match/mismatch of the second byte, and the fourth bit held in the match/mismatch map register 31 and indicating a match/mismatch of the first byte.

The AND circuit 41 performs an AND operation of the jth bit held in the match/mismatch map register 33 and indicating a match/mismatch of the third byte, the (j+1)th bit held in the match/mismatch map register 32 and indicating a match/mismatch of the second byte, and the (j+2)th bit held in the match/mismatch map register 31 and indicating a match/mismatch of the first byte.

The AND circuit 41 performs an AND operation of the seventh bit held in the match/mismatch map register 33 and indicating a match/mismatch of the third byte, the eighth bit held in the match/mismatch map register 32 and indicating a match/mismatch of the second byte, and the first bit lastly held in the match/mismatch map register 32, currently held in the register 51, and indicating a match/mismatch of the first byte.

The AND circuit 41 performs an AND operation of the eighth bit held in the match/mismatch map register 33 and indicating a match/mismatch of the third byte, the second bit lastly held in the match/mismatch map register 32, currently held in the register 52, and indicating a match/mismatch of the second byte, and the second bit lastly held in the match/mismatch map register 31, currently held in the register 51, and indicating a match/mismatch of the first byte.

A validity register 42 stores the operation results from the AND circuit 41 as in the second embodiment.

Similar to the second embodiment, the fourth embodiment can perform search even when three search object bytes exist over data of eight bytes that can be stored in the input register 11 and data before or after this 8 byte data.

Each of the above embodiments is merely an example and does not limit the present invention, so these embodiments can be variously modified within the technical scope of the present invention. For example, the search object byte string has three bytes in the above embodiments, but the number of bytes can be any number as long as it is 2 or more. Also, each embodiment uses the match/mismatch map registers 31 to 33 that indicate a match by “1” and a mismatch by “0”, and the AND circuit 41 that executes AND operations. However, it is also possible to use match/mismatch map registers that indicate a match by “0” and a mismatch by “1”, and an OR circuit that executes OR operations.

What is claimed is:

1. A byte string searching apparatus for searching for a search object byte string including a (a is an integer of not less than 2) consecutive bytes, comprising:
a comparators each of which compares externally input first data having n (n is an integer of not less than a) bytes with one of bytes from a first byte to an ath byte of the search object byte string, and outputs a comparison result indicating a match/mismatch of each byte; and
a logic operation circuit which executes a logic operation by using the comparison results from said comparators, thereby outputting the presence/absence of a byte string having a consecutive bytes,
wherein said a comparators select different bytes from the first byte to the ath byte of the search object byte string, and output the comparison results in parallel.

2. An apparatus according to claim 1, wherein said logic operation circuit outputs the presence/absence of a byte string having a consecutive bytes by using
comparison results, output from said comparators, of second data following the first data and having a predetermined number of bytes, and
a part of results of comparison of the first data with bytes from the first byte to an (a−1)th byte of the search object byte string.

3. An apparatus according to claim 1, wherein
said a comparators receive the externally input n byte data, compare the n byte data with the first byte, a jth (j is one of consecutive integers within a range of 1<j<a) byte, and the ath byte of the search object byte string, and output a first 1 byte comparison result, a jth 1 byte comparison result, and an ath 1 byte comparison result each indicating a match/mismatch of each byte,
the byte string searching apparatus further comprises a first match/mismatch map register, a jth match/mismatch map register, and an ath match/mismatch map register which respectively receive and store the first comparison result, the jth comparison result, and the ath comparison result from said comparators, and
said logic operation circuit has an AND circuit which outputs a 1 byte operation result by performing AND operation of values in corresponding bit positions in said first match/mismatch map register, said jth match/mismatch map register, and said ath match/mismatch map register, while data of the first to ath comparison results is stored as it is sequentially packed from a least significant bit (to be referred to as an LSB hereinafter) in said first to ath match/mismatch map registers, said first match/mismatch map register is shifted (a−1) bits to an upper bit side, said jth match/mismatch map register is shifted (a−j) bits to an upper bit side, and said (a−1)th match/mismatch map register is shifted one bit to an upper bit side.

4. An apparatus according to claim 1, wherein
said a comparators receive the externally input n byte data, compare the n byte data with the first byte, a jth (j is one of consecutive integers within a range of 1<j<a) byte, and the ath byte of the search object byte string, and output a first 1 byte comparison result, a jth 1 byte comparison result, and an ath 1 byte comparison result each indicating a match/mismatch of each byte,
the byte string searching apparatus further comprises a first match/mismatch map register, a jth match/mismatch map register, and an ath match/mismatch map register which respectively receive and store the first comparison result, the jth comparison result, and the ath comparison result from said comparators, and
said logic operation circuit has an AND circuit which outputs a 1 byte operation result by performing an AND operation of values in corresponding bit positions in said first match/mismatch map register, said jth match/mismatch map register, and said ath match/mismatch map register, while data of the first to ath comparison results is stored as it is sequentially packed from a most significant bit (to be referred to as an MSB hereinafter) in said first to ath match/mismatch map registers, said first match/mismatch map register is shifted (a−1) bits to a lower bit side, said jth match/mismatch map register is shifted (a−j) bits to a lower bit side, and said (a−1)th match/mismatch map register is shifted one bit to a lower bit side.

5. An apparatus according to claim 1, wherein
said a comparators comprise:
a first comparator which receives the externally input n byte data, compares the n byte data with the first byte of the search object byte string, and outputs a first 1 byte comparison result indicating a match/mismatch of each byte;
a jth (j is one of consecutive integers within a range of 1<j<a) comparator which receives the externally input n byte data, compares the n byte data with a jth byte of the search object byte string, and outputs a jth 1 byte comparison result indicating a match/mismatch of each byte; and
an ath comparator which receives the externally input n byte data, compares the n byte data with the ath byte of the search object byte string, and outputs an ath 1 byte comparison result indicating a match/mismatch of each byte,
the byte string searching apparatus further comprises:
a first match/mismatch map register which receives and stores the first comparison result from said first comparator;
a jth match/mismatch map register which receives and stores the jth comparison result from said jth comparator; and
an ath match/mismatch map register which receives and stores the ath comparison result from said ath comparator,
said logic operation circuit has an AND circuit which, while data of the first to ath comparison results is stored as it is sequentially packed from an LSB in said first to ath match/mismatch map registers, outputs a 1 byte operation result by
performing an AND operation of a value of a first bit in the ath comparison result stored in said ath match/mismatch map register and a value indicating a mismatch,
performing an AND operation of a value of a jth bit in the ath comparison result stored in said ath match/mismatch map register, a value of a (j−1)th bit in the (a−(j−1))th comparison result stored in said (a−(j−1))th match/mismatch map register, and the value indicating a mismatch,
performing an AND operation of a value of an (n/8)th bit in the ath comparison result stored in said ath match/mismatch map register, a value of an ((n/8)−(j−1))th bit in the (a−(j−1))th comparison result stored in said (a−(j−1))th match/mismatch map register, and a value of a first bit in the first comparison result stored in said first match/mismatch map register, and
the byte string searching apparatus further comprises a validity register which receives and holds the operation result from said AND circuit, and in which a bit position storing a value indicating a match corresponds to a position of the ath byte of the search object byte string in the data.

6. An apparatus according to claim 1, wherein
said a comparators comprise:
a first comparator which receives the externally input n byte data, compares the n byte data with the first byte of the search object byte string, and outputs a first 1 byte comparison result indicating a match/mismatch of each byte;
a jth (j is one of consecutive integers within a range of 1<j<a) comparator which receives the externally input n byte data, compares the n byte data with a jth byte of the search object byte string, and outputs a jth 1 byte comparison result indicating a match/mismatch of each byte; and
an ath comparator which receives the externally input n byte data, compares the n byte data with the ath byte of the search object byte string, and outputs an ath 1 byte comparison result indicating a match/mismatch of each byte,
the byte string searching apparatus further comprises:
a first match/mismatch map register which receives and stores the first comparison result from said first comparator;
a jth match/mismatch map register which receives and stores the jth comparison result from said jth comparator; and
an ath match/mismatch map register which receives and stores the ath comparison result from said ath comparator,
said logic operation circuit has an AND circuit which, while data of the first to ath comparison results is stored as it is sequentially packed from an MSB in said first to ath match/mismatch map registers, outputs a 1 byte operation result by
performing an AND operation of a value of a first bit in the ath comparison result stored in said ath match/mismatch map register, a value of a jth bit in the (a−(j−1))th comparison result stored in said (a−(j−1))th match/mismatch map register, and a value of an (a−(j−1))th bit in the first comparison result stored in said first match/mismatch map register,
performing an AND operation of a value of a jth bit in the ath comparison result stored in said ath match/mismatch map register, a value of a (j+1)th bit in the (a−(j−1))th comparison result stored in said (a−(j−1))th match/mismatch map register, and a value of an ath bit in the first comparison result stored in said first match/mismatch map register, and
performing an AND operation of a value of an (n/8)th bit in the ath comparison result stored in said ath match/mismatch map register, and a value indicating a mismatch, and
the byte string searching apparatus further comprises a validity register which receives and holds the operation result from said AND circuit, and in which a bit position storing a value indicating a match corresponds to a position of the ath byte of the search object byte string in the data.

7. An apparatus according to claim 1, wherein
said a comparators comprise:
a first comparator which receives the externally input n byte data, compares the n byte data with the first byte of the search object byte string, and outputs a first 1 byte comparison result indicating a match/mismatch of each byte;
a jth (j is one of consecutive integers within a range of 1<j<a) comparator which receives the externally input n byte data, compares the n byte data with a jth byte of the search object byte string, and outputs a jth 1 byte comparison result indicating a match/mismatch of each byte; and
an ath comparator which receives the externally input n byte data, compares the n byte data with the ath byte of the search object byte string, and outputs an ath 1 byte comparison result indicating a match/mismatch of each byte,
the byte string searching apparatus further comprises:
a first match/mismatch map register which receives and stores the first comparison result from said first comparator;
a jth match/mismatch map register which receives and stores the jth comparison result from said jth comparator; and
an ath match/mismatch map register which receives and stores the ath comparison result from said ath comparator,
when data of the first to ath comparison results is stored as it is sequentially packed from an LSB in said first to ath match/mismatch map registers,
the byte string searching apparatus further comprises:
a first register which receives and stores an (n/8)th bit and an (n/8−(a−j))th bit in the first comparison result lastly stored in said first match/mismatch map register;
a jth register which receives and stores an (n/8)th bit and an (n/8−(a−(n+1)))th bit in the jth comparison result lastly stored in said jth match/mismatch map register; and
an (a−1)th register which receives and stores an (n/8)th bit in the (a−1)th comparison result lastly stored in said (a−1)th match/mismatch map register,
said logic operation circuit has an AND circuit which outputs a 1 byte operation result by
performing an AND operation of a value of a first bit in the ath comparison result stored in said ath match/mismatch map register, a value of an (n/8−(n−2))th bit stored in said (a−(j−1))th register, and a value of an (a−(j−1))th bit in said first register,
performing an AND operation of a value of a jth bit in the ath comparison result stored in said ath match/mismatch map register, a value of a (j−1)th bit in the (a−(j−1))th comparison result stored in said (a−(j−1))th match/mismatch map register, and a value of an (a−j)th bit in said first register, and
performing an AND operation of a value of an (n/8)th bit in the ath comparison result stored in said ath match/mismatch map register, a value of an (n/8−(j−1))th bit in the (a−(j−1))th comparison result stored in said (a−(j−1))th match/mismatch map register, and a value of an (8−(a−1))th bit in the first comparison result stored in said first match/mismatch map register, and
the byte string searching apparatus further comprises a validity register which receives and holds the operation result from said AND circuit, and in which a bit position storing a value indicating a match corresponds to a position of the ath byte of the search object byte string in the data.

8. An apparatus according to claim 1, wherein
said a comparators comprise:
a first comparator which receives the externally input n byte data, compares the n byte data with the first byte of the search object byte string, and outputs a first 1 byte comparison result indicating a match/mismatch of each byte;
a jth (j is one of consecutive integers within a range of 1<j<a) comparator which receives the externally input n byte data, compares the n byte data with a jth byte of the search object byte string, and outputs a jth 1 byte comparison result indicating a match/mismatch of each byte; and
an ath comparator which receives the externally input n byte data, compares the n byte data with the ath byte of the search object byte string, and outputs an ath 1 byte comparison result indicating a match/mismatch of each byte,
the byte string searching apparatus further comprises:
a first match/mismatch map register which receives and stores the first comparison result from said first comparator;
a jth match/mismatch map register which receives and stores the jth comparison result from said jth comparator; and
an ath match/mismatch map register which receives and stores the ath comparison result from said ath comparator,
data of the first to ath comparison results is stored as it is sequentially packed from an MSB in said first to ath match/mismatch map registers,
said logic operation circuit comprises:
a first register which receives and stores a first bit and an (a−(j−1))th bit in the first comparison result lastly stored in said first match/mismatch map register;
a jth register which receives and stores a first bit and an (a−j)th bit in the jth comparison result lastly stored in said jth match/mismatch map register;
an (a−1)th register which receives and stores a first bit in the (a−1)th comparison result lastly stored in said (a−1)th match/mismatch map register; and
an AND circuit which outputs a 1 byte operation result by
performing an AND operation of a value of a first bit in the ath comparison result stored in said ath match/mismatch map register, a value of a jth bit in the (a−(j−1))th comparison result stored in said (a−(j−1))th match/mismatch map register, and a value of an (a−1)th bit in the first comparison result stored in said first match/mismatch map register,
performing an AND operation of a value of a jth bit in the ath comparison result stored in said ath match/mismatch map register, a value of a (j+1)th bit in the (a−(j−1))th comparison result stored in said (a−(j−1))th match/mismatch map register, and a value of an ath bit stored in said first match/mismatch map register,
performing an AND operation of a value of an (n/8-1)th bit in the ath comparison result stored in said ath match/mismatch map register, a value of an (n/8−(n−2))th bit in the (j−1))th comparison result stored in said (a−(j−1))th match/mismatch map register, and a value of an (a−(j−1))th bit in the first comparison result stored in said first register, and
performing an AND operation of a value of an (n/8)th bit in the ath comparison result stored in said ath match/mismatch map register, a value of a (j−1)th bit in the (a−(j−1))th comparison result stored in said (a−(j−1))th match/mismatch map register, and a value of an (a−1)th bit in the first comparison result stored in said first register, and
the byte string searching apparatus further comprises a validity register which receives and holds the operation result from said AND circuit, and in which a bit position storing a value indicating a match corresponds to a position of the ath byte of the search object byte string in the data.

9. A byte string searching method of searching for a search object byte string including a (a is an integer of not less than 2) consecutive bytes, comprising:
allowing a comparators to compare externally input first data having n (n is an integer of not less than a) bytes with one of bytes from a first byte to an ath byte of the search object byte string, and output comparison results indicating a match/mismatch of each byte; and
allowing a logic operation circuit to execute a logic operation by using the comparison results from the comparators, thereby outputting the presence/absence of a byte string having a consecutive bytes,
wherein when the comparison results are output from the a comparators, different bytes are selected from the first byte to the ath byte of the search object byte string, and the comparison results are output in parallel.

10. A method according to claim 9, wherein
when outputting the comparison results from the a comparators, the comparators compare data having n (n is an integer of not less than a) bytes with the first byte, a jth (j is one of consecutive integers within a range of 1<j<a) byte, and the ath byte of the search object byte string, and generate a first 1 byte comparison result, a jth 1 byte comparison result, and an ath 1 byte comparison result each indicating a match/mismatch of each byte,
the first comparison result, the jth comparison result, and the ath comparison result are respectively stored in a first match/mismatch map register, a jth math/mismatch map register, and an ath match/mismatch map register, and data of the first to ath comparison results is stored as it is sequentially packed from an LSB in the first to ath match/mismatch map registers, and
when outputting the presence/absence of a byte string having a consecutive bytes from the logic operation circuit, the first match/mismatch map register is shifted (a−1) bits to an upper bit side, the jth match/mismatch map register is shifted (a−j) bits to an upper bit side, the (a−1)th match/mismatch map register is shifted one bit to an upper bit side, and an AND circuit generates an 8 bit operation result by performing an AND operation of values in corresponding bit positions in the first match/mismatch map register, the jth match/mismatch map register, and the ath match/mismatch map register.

11. A method according to claim 9, wherein
when outputting the comparison results from the a comparators, the comparators compare data having n (n is an integer of not less than a) bytes with the first byte, a jth (j is one of consecutive integers within a range of 1<j<a) byte, and the ath byte of the search object byte string, and generate a first 1 byte comparison result, a jth 1 byte comparison result, and an ath 1 byte comparison result each indicating a match/mismatch of each byte,
the first comparison result, the jth comparison result, and the ath comparison result are respectively stored in a first match/mismatch map register, a jth math/mismatch map register, and an ath match/mismatch map register, and data of the first to ath comparison results is stored as it is sequentially packed from an MSB in the first to ath match/mismatch map registers, and
when outputting the presence/absence of a byte string having a consecutive bytes from the logic operation circuit, the first match/mismatch map register is shifted (a−1) bits to a lower bit side, the jth match/mismatch map register is shifted (a−j) bits to a lower bit side, the (a−1)th match/mismatch map register is shifted one bit to a lower bit side, and an AND circuit generates an 8 bit operation result by performing an AND operation of values in corresponding bit positions in the first match/mismatch map register, the jth match/mismatch map register, and the ath match/mismatch map register.

12. A method according to claim 9, wherein
when outputting the comparison results from the a comparators,
the n byte data is supplied to the first comparator and compared with the first byte of the search object byte string, thereby generating a first n bit comparison result indicating a match/mismatch of each byte,
the n byte data is supplied to a jth (1 is one of consecutive integers within a range of 1<j<a) comparator and compared with a jth byte of the search object byte string, thereby generating a jth n bit comparison result indicating a match/mismatch of each byte,
the n byte data is supplied to an ath comparator and compared with the ath byte of the search object byte string, thereby generating an ath n bit comparison result indicating a match/mismatch of each byte,
a first match/mismatch map register receives and stores the first comparison result from the first comparator,
a jth match/mismatch map register receives and stores the jth comparison result from the jth comparator,
an ath match/mismatch map register receives and stores the ath comparison result from the ath comparator, data of the first to ath comparison results being stored as it is sequentially packed from an LSB in the first to ath match/mismatch map registers,
when outputting the presence/absence of a byte string having a consecutive bytes from the logic operation circuit,
an AND circuit generates an 8 bit operation result by
performing an AND operation of a value of a first bit in the ath comparison result stored in the ath match/mismatch map register, and a value indicating a mismatch,
performing an AND operation of a value of a jth bit in the ath comparison result stored in the ath match/mismatch map register, a value of a first bit in the (a−1)th comparison result stored in the (a−(j−1))th match/mismatch map register, and the value indicating a mismatch, and
performing an AND operation of a value of an (n/8)th bit in the ath comparison result stored in the ath match/mismatch map register, a value of an (n/8−1)th bit in the (a−(n−1))th comparison result stored in the (a−(n−1))th match/mismatch map register, and a value of a first bit in the first comparison result stored in the first match/mismatch map register, and
a validity register receives and stores the operation result such that a bit position storing a value indicating a match corresponds to a position of the ath byte of the search object byte string in the data.

13. A method according to claim 9, wherein
when outputting the comparison results from the a comparators,
the n byte data is supplied to the first comparator and compared with the first byte of the search object byte string, thereby generating a first n bit comparison result indicating a match/mismatch of each byte,
the n byte data is supplied to a jth (j is one of consecutive integers within a range of 1<j<a) comparator and compared with a jth byte of the search object byte string, thereby generating a jth n bit comparison result indicating a match/mismatch of each byte,
the n byte data is supplied to an ath comparator and compared with the ath byte of the search object byte string, thereby generating an ath n bit comparison result indicating a match/mismatch of each byte,
a first match/mismatch map register receives and stores the first comparison result from the first comparator,
a jth match/mismatch map register receives and stores the jth comparison result from the jth comparator,
an ath match/mismatch map register receives and stores the ath comparison result from the ath comparator, data of the first to ath comparison results being stored as it is sequentially packed from an MSB in the first to ath match/mismatch map registers,
when outputting the presence/absence of a byte string having a consecutive bytes from the logic operation circuit,
an AND circuit generates an 8 bit operation result by
performing an AND operation of a value of a first bit in the ath comparison result stored in the ath match/mismatch map register, a value of a jth bit in the (a−(j−1))th comparison result stored in the (a−(j−1))th match/mismatch map register, and a value of an (a−1)th bit in the first comparison result stored in the first match/mismatch map register,
performing an AND operation of a value of a jth bit in the ath comparison result stored in the ath match/mismatch map register, a value of a (j+1)th bit in the (a−(j−1))th comparison result stored in the (a−(j−1))th match/mismatch map register, and a value of an ath bit in the first comparison result stored in the first match/mismatch map register, and
performing an AND operation of a value of an (n/8)th bit in the ath comparison result stored in the ath match/mismatch map register, and a value indicating a mismatch, and
a validity register receives and stores the operation result such that a bit position storing a value indicating a match corresponds to a position of the ath byte of the search object byte string in the data.
